(19) United States
(12) Patent Application Publication
(10) Pub. No.: US 2012/0247262 A1
(43) Pub. Date: Oct. 4, 2012

(54) BRAKE CABLE SHEATH FOR BICYCLE

(76) Inventor: Yuan-Hung WEN, Hemei Town (TW)

(21) Appl. No.: 13/078,908

(22) Filed: Apr. 1, 2011

(51) Int. Cl. B62L 3/02; F16C 1/26

(52) U.S. Cl. 74/502.2; 74/502.5

(57) ABSTRACT

A brake cable sheath for bicycle of the present invention includes a plurality of tubes. The tubes can be serial arranged for a brake cable to be received therein. Each tube is formed with two fixation holes and two slots. Each slot communicates radially with one of the fixation holes, so that wires may be received in the fixation holes via the slots. As such, the tubes of the brake cable sheath can be assembled and engaged with wires. The brake cable sheath can be sustained stably to reduce shaking.

### BACKGROUND OF THE INVENTION

1. Field of the Invention

The present invention relates to a sheath which is provided for brake cable to be received therein.

2. Description of the Prior Art

Brake cable sheath is provided for brake cable or the like to be received therein so as to protect the cable or the user.

Conventional cable sheath, as shown in U.S. Pat. No. 6,250,175 or U.S. Pat. No. 7,784,376, includes plural tubes which are serially arranged. The cable, which includes a plastic tube and a metal wire received in the plastic tube, is received in the tubes of the cable sheath.

However, the cable sheath and the cable would shake arbitrarily after they are assembled on a bicycle. The plastic tube of the cable would probably be produced with a residual stress. The wire of the cable and the cable sheath would be bent by the plastic tube together. Secondly, the wire would be pull to move in the plastic tube. The plastic tube and the cable sheath would be bent also. That is, the cable and the cable sheath can be hardly kept at a determined position static.

The present invention is, therefore, arisen to obviate or at least mitigate the above mentioned disadvantages.

### SUMMARY OF THE INVENTION

The main object of the present invention is to provide a brake cable sheath for bicycle which is able to hold the brake cable at a predetermined position static.

To achieve the above and other objects, a brake cable sheath for bicycle of the present invention includes plural tubes. Each tube has a first end, a second end, an outer surface, and an inner surface. The inner surface defines a penetrating hole. The penetrating hole extends axially from the first end to the second end. The second end of each tube is adapted for the first end of another tube to abut thereagainst, so that the tubes are serially arranged.

Each tube is formed with at least two fixation holes and at least two slots. Each fixation hole extends axially. Each fixation hole has a first opening and a second opening. Each slot is dented radially from the outer surface. The slots respectively communicate with one of the fixation holes. The slots respectively extend from the corresponding first opening to the corresponding second opening, so that each fixation hole is adapted for a wire to be radially received therein via the corresponding slot.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a tube of a first embodiment of the present invention;

FIG. 2 is a cross sectional drawing showing a tube of a first embodiment of the present invention;

FIG. 3 is a stereogram showing a handle of a first embodiment of the present invention;

FIG. 4 is a combination drawing showing a first embodiment of the present invention;

FIG. 5 is a cross sectional drawing showing a first embodiment of the present invention;

FIG. 6 is a stereogram showing a tube of a second embodiment of the present invention;

FIG. 7 is a stereogram showing a tube of a third embodiment of the present invention;

FIG. 8 is a cross sectional drawing showing a tube of a third embodiment of the present invention.

### DETAILED DESCRIPTION OF THE PREFERRED EMBODIMENTS

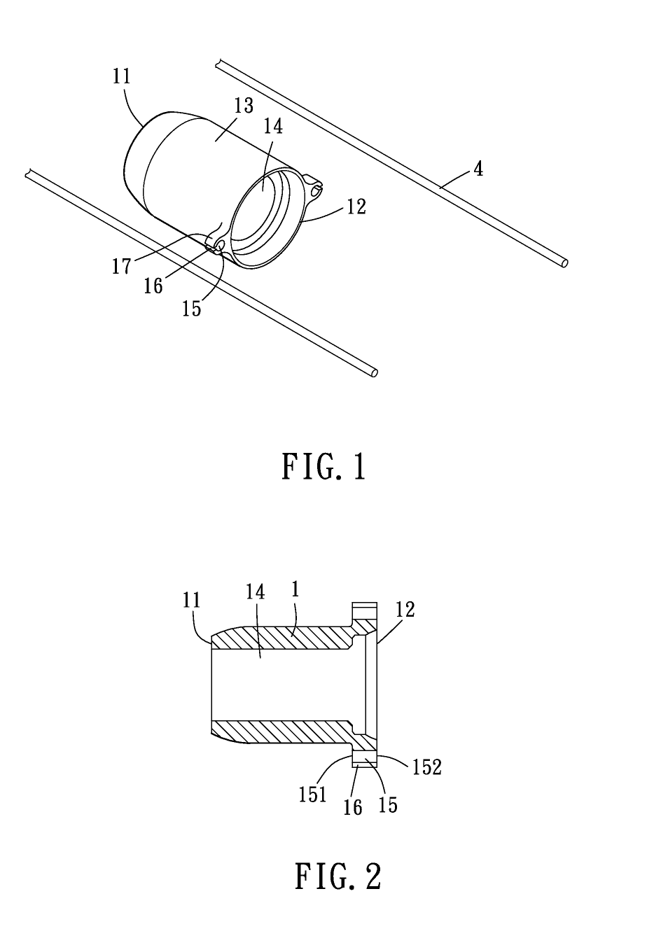

Please refer to FIG. 1 to FIG. 3 for a first embodiment of the present invention. The brake cable sheath of the present embodiment includes a plurality of tubes 1. Each tube 1 has a first end 11, a second end 12, an outer surface 13, and an inner surface 14. A penetrating hole is defined by the inner surface 14. The penetrating hole extends axially from the first end 11 to the second end 12. The second end 12 is provided for the first end of another tube to abut thereagainst. As such, the tubes can be arranged serially.

Each tube 1 is further formed with at least two fixation holes 15 and at least two slots 16. Each fixation hole 15 extends axially. Each fixation hole 15 has a first opening 151 and a second opening 152. Each slot 16 is dented radially from the outer surface 13. The slots 16 communicate respectively with one of the fixation holes 15. The slots 16 extend respectively from the corresponding first opening 151 to the corresponding second opening 152. Preferably, the fixation hole 15 is located by two sides of the penetrating hole. In other words, the penetrating hole is located between the fixation holes 15.

Furthermore, each tube 1 includes a tubular main body and at least two protrusions 17. The protrusions 17 radially protrude from the main body. The fixation holes 15 are respectively located on one of the protrusions 17, and the slots 16 are respectively located on one of the protrusions 17, also.

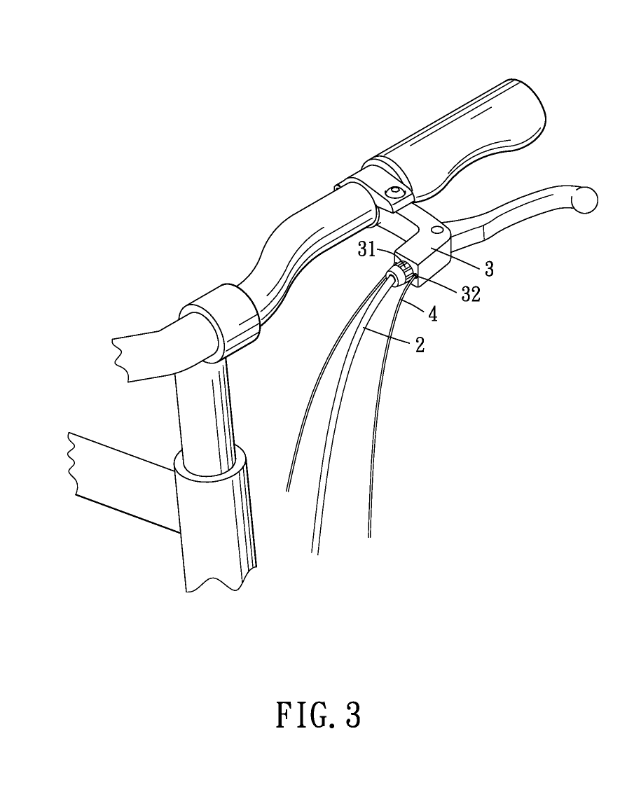

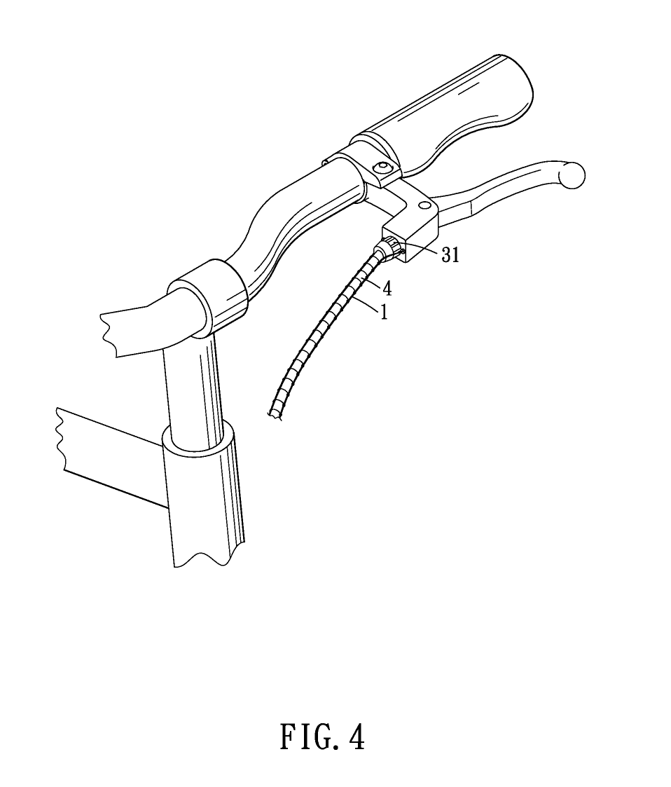

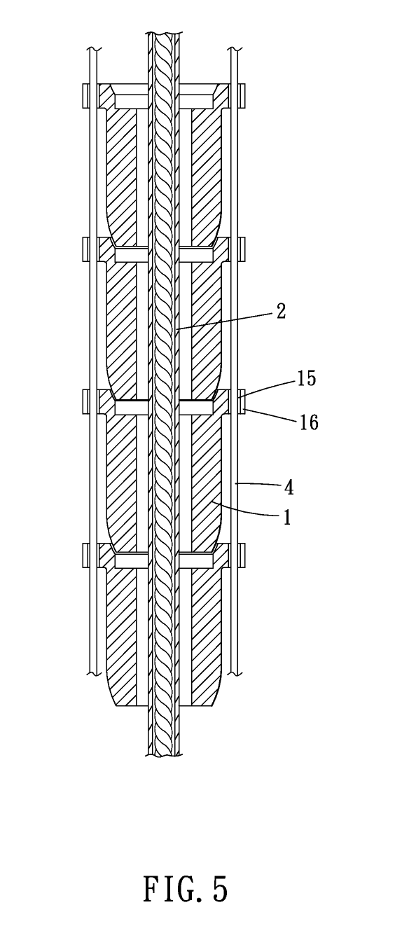

Accordingly, referring to FIG. 3 to FIG. 5, the brake cable sheath of the present embodiment can be put on a brake cable 2 of bicycle so as to be assembled in a brake handle assembly 3. The brake handle assembly includes a handle, a brake cable 2, and at least two wires 4. The brake cable 2 and the wires 3 are disposed on the handle. An adjusting device 31 may be disposed on the handle. The adjusting device 31 is used for pulling the brake cable 2 axially so as to fasten or loosen the brake cable 2. Preferably, the brake cable 2 is located between the wires 4. Other two adjusting devices 32 may be disposed on the handle so as to pull the wires 4 axially, as shown in FIG. 3. In fabrication, the brake cable 2 is received in the penetrating holes of the tubes 1. The wires 4 are then respectively and radially received in the fixation holes 15 via the slots 16. As such, the wires 4 are buckled in the fixation holes 15 via the slots 16. Fabrication by that piercing the ends of the wires 4 into the fixation holes 15 is not necessary. Therefore, easily and quickly fabrication is achieved.

When the fabrication is complete, the wires 4 are arranged by two sides of the brake cable 2. The wires 4 may be tightened to fix the brake cable sheath and the brake cable 2. That is, shaking and bending is reduced so as to keep the brake cable and the brake cable sheath at a predetermined position statically.

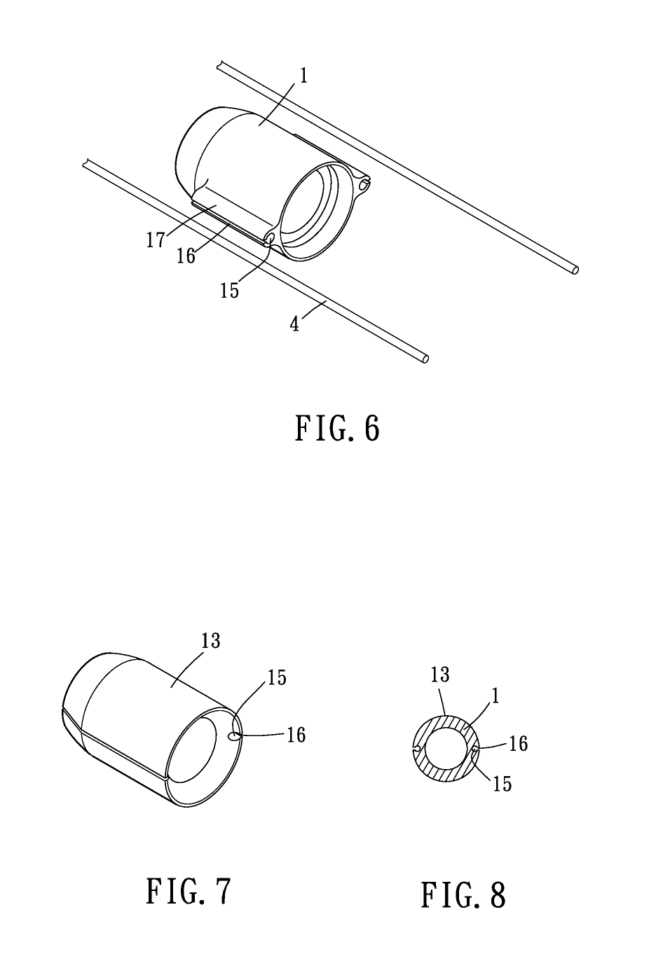

Please refer to FIG. 6. In a second embodiment of the present invention, the protrusions 17 may be axially extended. An axial length of the protrusions 17 may be longer than half of an axial length of the tube 1. Length of the fixation holes 15 is naturally lengthened. As such, the wires 4 could hold the tubes 1 better to reduce the shaking and bending.

Please refer to FIG. 7 and FIG. 8. In a third embodiment of the present invention, the outer surface 13 of each tube 1 may be made a cylindrical surface. Structure strength of the fixation holes 15 and the slots 16 may be strengthened.

In other possible embodiments of the present invention, the quantity of the fixation holes 15, the slots 16, and the wires 4 may be increased for an enhanced stable performance. Preferably, the fixation holes 15, the slots 16, and the wires 4 could be equidistantly arranged around the brake cable 2.

To conclude, the brake cable sheath of the present invention can be assembled with the brake cable so as to cover the brake cable. The brake cable and the user are protected. Further, the brake cable is held by the brake cable sheath and the wires. Shaking and bending of the brake cable is restrained. Otherwise, the slots are provided for wires fabrication. Easily and quickly fabrication is achieved.

What is claimed is:

1. A brake cable sheath for bicycle, comprising plural tubes, each tube having a first end, a second end, an outer surface, and an inner surface, the inner surface defining a penetrating hole, the penetrating hole extending axially from the first end to the second end, the second end of each tube being adapted for the first end of another tube to abut thereagainst, so that the tubes are serially arranged;
wherein each tube is formed with at least two fixation holes and at least two slots, each fixation hole extends axially, each fixation hole has a first opening and a second opening, each slot is dented radially from the outer surface, the slots respectively communicate with one of the fixation holes, the slots respectively extend from the corresponding first opening to the corresponding second opening, so that each fixation hole is adapted for a wire to be radially received therein via the corresponding slot.

2. The brake cable sheath of claim 1, wherein each tube has a tubular main body and at least two protrusions, the protrusions radially protrude from the main body, the fixation holes are respectively located on one of the protrusions, and the slots are respectively located on one of the protrusions.

3. The brake cable sheath of claim 1, wherein the outer surface is a cylindrical surface.

4. The brake cable sheath of claim 1, wherein the penetrating hole is located between the fixation holes.

5. The brake cable sheath of claim 2, wherein the penetrating hole is located between the fixation holes.

6. The brake cable sheath of claim 3, wherein the penetrating hole is located between the fixation holes.

7. A brake handle assembly, comprising the brake cable sheath of claim 1, further comprising a handle, a brake cable, and at least two wires, the brake cable and the wires being disposed on the handle, the brake cable being located between the wires, the brake cable being received in the penetrating holes of the tubes, the wires being respectively and radially received in the fixation holes via the slots so as to be buckled in the fixation holes.

8. The brake cable sheath of claim 7, wherein each tube has a tubular main body and at least two protrusions, the protrusions radially protrude from the main body, the fixation holes are respectively located on one of the protrusions, and the slots are respectively located on one of the protrusions.

9. The brake cable sheath of claim 7, wherein the outer surface is a cylindrical surface.

10. The brake cable sheath of claim 7, wherein the penetrating hole is located between the fixation holes.

11. The brake cable sheath of claim 8, wherein the penetrating hole is located between the fixation holes.

12. The brake cable sheath of claim 9, wherein the penetrating hole is located between the fixation holes.
